(19) United States
(12) Patent Application Publication
(10) Pub. No.: US 2026/0263203 A1
(43) Pub. Date: Sep. 10, 2026

(54) NON-INVASIVE POSITIVE PRESSURE VENTILATION SYSTEM

(71) Applicant: University of Rochester, Rochester, NY (US)

(72) Inventor: Andrew Dylag, Rochester, NY (US)

(73) Assignee: University of Rochester, Rochester, NY (US)

(21) Appl. No.: 19/560,910

(22) Filed: Mar. 9, 2026

Related U.S. Application Data
(60) Provisional application No. 63/769,382, filed on Mar. 10, 2025.

(51) Int. Cl. A61D 7/00

(52) U.S. Cl. CPC A61D 7/00

(57) ABSTRACT

A non-invasive ventilation system is disclosed. The system includes a plenum chamber configured to provide pressure to one or more branches. Each of the one or more branches is configured to provide the pressure of the plenum chamber to a separate animal. The system further includes a dynamic pressure circuit interfacing with the plenum chamber, the dynamic pressure circuit including a ventilator configured to apply a time-varying pressure to the plenum chamber. The system further includes a continuous pressure circuit interfacing with the plenum chamber through a check valve. The continuous pressure circuit is configured to apply a positive pressure to the plenum chamber. The system further includes a control system configured to operate the ventilator to provide the time-varying pressure.

### CROSS-REFERENCE TO RELATED APPLICATIONS

The present application claims priority under 35 U.S.C. § 119(e) to U.S. Provisional Patent Application No. 63/769,382, filed Mar. 10, 2025, which is incorporated by reference herein in its entirety.

### GOVERNMENT INTERESTS

This invention was made with government support under HL155491 awarded by the National Institutes of Health. The government has certain rights in the invention.

### BACKGROUND

Bronchopulmonary dysplasia (BPD), also known as chronic lung disease (CLD), is a chronic lung disease which affects premature infants. It is also more common in infants who receive prolonged mechanical ventilation to treat respiratory distress syndrome caused by, e.g., structural immaturity in the lungs. Prolonged high oxygen delivery in premature infants may cause airway and/or alveolar injury, with inflammation and scarring, which may result in long-term chronic lung disease. Adult survivors may have airway hyperreactivity and have a higher risk of developing obstructive lung disease. Phenotypes in adult survivors have been "broadly categorized as predominantly asthma-like, emphysematous, or consistent with pulmonary hypertension." Animal models of BPD are used to study the causes of the disease and develop treatments. These models include rodents and rabbits. These models primarily aim at inducing alveolar simplification similar to what is seen in infants with BPD. However, ventilating neonatal rodents suffers from significant technical disadvantages related to their small size, the inefficiency of ventilating only one animal at a time, and the need for a tracheostomy (which limits long-term recovery after exposure). This document describes methods and systems that address issues such as those discussed above, and/or other issues.

### SUMMARY

The present disclosure describes embodiments related to non-invasive ventilation systems, applications, and animal models prepared using such systems. A non-invasive ventilation system includes a plenum chamber configured to provide pressure to one or more branches. Each of the one or more branches is configured to provide the pressure of the plenum chamber to a separate animal. The system further includes a dynamic pressure circuit interfacing with the plenum chamber, the dynamic pressure circuit including a ventilator configured to apply a time-varying pressure to the plenum chamber. The system further includes a continuous pressure circuit interfacing with the plenum chamber through a check valve. The continuous pressure circuit is configured to apply a positive pressure to the plenum chamber. The system further includes a control system configured to operate the ventilator to provide the time-varying pressure.

Implementations of the disclosure may include one or more of the following optional features. In some examples the continuous pressure circuit further includes a humidifier. In some examples, the one or more branches include multiple branches, each of which is associated with a separate animal. Each of the branches may include an elastic cuff configured to form a seal with a nose and mouth of the associated animal. The plenum chamber may include an adjustable leak. The adjustable leak may be manually adjustable. The non-invasive ventilation system may be further configured to deliver one or more therapeutic compounds to each separate animal. The non-invasive ventilation system may further include a gas blender configured to adjust a fraction of oxygen in the plenum chamber. In some examples, the system includes one or more temperature-controllable pads interfaced with the control system.

A method of preparing an animal model includes configuring a non-invasive ventilation system to provide a time-varying pressure including (i) a positive end-expiratory pressure (PEEP) being greater than ambient air pressure, (ii) a peak inspiratory pressure (PIP) being greater than the PEEP, (iii) an inspiratory duration, and (iv) an inspiratory rate. The method further includes placing at least one animal in an elastic cuff configured to form a seal with a nose and mouth of the animal, the elastic cuff interfaced with a branch of the non-invasive ventilation system to provide artificial respiration to the at least one animal based on the time-varying pressure. The method further includes providing the artificial respiration to the at least one animal for a period of time during each of several days, causing a characteristic of the at least one animal to approximate a pathological condition of a human infant.

Implementations of the disclosure may include one or more of the following optional features. In some examples, the pathological condition is bronchopulmonary dysplasia. The characteristic of the animal may be lung stiffness. Providing the artificial respiration may include providing the artificial respiration to the animal for up to six hours per day for at least four days. Configuring the non-invasive ventilation system may include configuring the continuous pressure circuit to provide the positive end-expiratory pressure. Configuring the non-invasive ventilation system may include configuring the control system to operate the ventilator at the inspiratory duration and/or the inspiratory rate. In some examples, the method includes providing the artificial respiration to animals that have not undergone tracheostomy. The at least one animal may be a non-human mammal. The non-human mammal may be a rodent or a non-human primate. The non-human mammal may be a mouse, rabbit, rat, hamster, guinea pig, ferret, cat, dog, or monkey. The method may further include delivering, by the non-invasive ventilation system, one or more therapeutic compounds to the at least one animal. The method may further include monitoring, by the control system, the time-varying pressure.

Also within the scope of this disclosure is a non-human animal that is prepared according to a method described herein.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 shows an example environment for ventilating animals.

FIG. 2 shows a flowchart for an example method according to an embodiment.

FIG. 3 illustrates example hardware that may be used to contain or implement program instructions.

In the drawings, like reference numbers generally indicate identical or similar elements. Additionally, generally, the left-most digit(s) of a reference number identifies the drawing in which the reference number first appears.

### DETAILED DESCRIPTION

As used in this document, the singular forms “a,” “an,” and “the” include plural references unless the context clearly dictates otherwise. Unless defined otherwise, all technical and scientific terms used herein have the same meaning(s) as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such as “first” and “second” are used to modify a noun or phrase, such use is simply intended to distinguish one item from another and is not intended to require a sequential order unless specifically stated. The term “about” when used in connection with a numeric value, is intended to include values that are close to, but not exactly, the number. For example, in some embodiments, the term “about” may include values that are within +/- 10 percent of the value.

The present disclosure relates generally to methods and systems of providing non-invasive, positive pressure, ventilation (NIPPV) to animals without requiring a tracheostomy and particularly to the use of NIPPV to prepare animal models for the study of BPD. That is, exposing neonatal experimental animals (such as rodents, rabbits, or ferrets) to NIPPV may cause long-term structure/function changes in organs, such as the lungs, of the animal, which may mimic BPD in humans. After exposure, researchers may study the animals to better understand BPD and determine causes and cures.

The disclosed systems and methods may also be used to study a variety of other diseases and/or conditions including, but not limited to, neonatal conditions related to prematurity, such as respiratory distress syndrome, bronchopulmonary dysplasia, apnea of prematurity, persistent pulmonary hypertension of the newborn, neonatal pneumonia, meconium aspiration syndrome, neonatal sepsis with respiratory failure, perinatal asphyxia, and/or congenital diaphragmatic hernia. The disclosed systems and methods may also be used to study pulmonary and respiratory conditions such as acute respiratory distress syndrome, chronic obstructive pulmonary disease, pneumonia, pulmonary edema, asthma, cystic fibrosis, obstructive sleep apnea, pulmonary embolism, and/or lung contusion. The disclosed systems and methods may also be used to study neurological and neuromuscular conditions such as traumatic brain injury, stroke, spinal cord injury, amyotrophic lateral sclerosis, Guillain-Barré syndrome, myasthenia gravis, multiple sclerosis, and/or congenital central hypoventilation syndrome.

The disclosed systems and methods may also be used to study cardiac conditions such as congestive heart failure, cardiac arrest, cardiogenic shock, and congenital heart disease. The disclosed systems and methods may also be used to study infectious diseases and sepsis such as septic shock, COVID-19, and/or Tuberculosis. The disclosed systems and methods may also be used to study toxicology and/or drug overdose such as poisoning from chemical agents. The disclosed systems and methods may also be used to study anesthetic and post-surgical indications such as post-surgical recovery, anesthesia-related respiratory depression, and/or airway obstruction. the disclosed systems and methods may also be used to study various genetic diseases. the disclosed systems and methods may also be used in conjunction with knockout models (e.g., of rodents) having various diseases or conditions, including (but not limited to) pulmonary derangements.

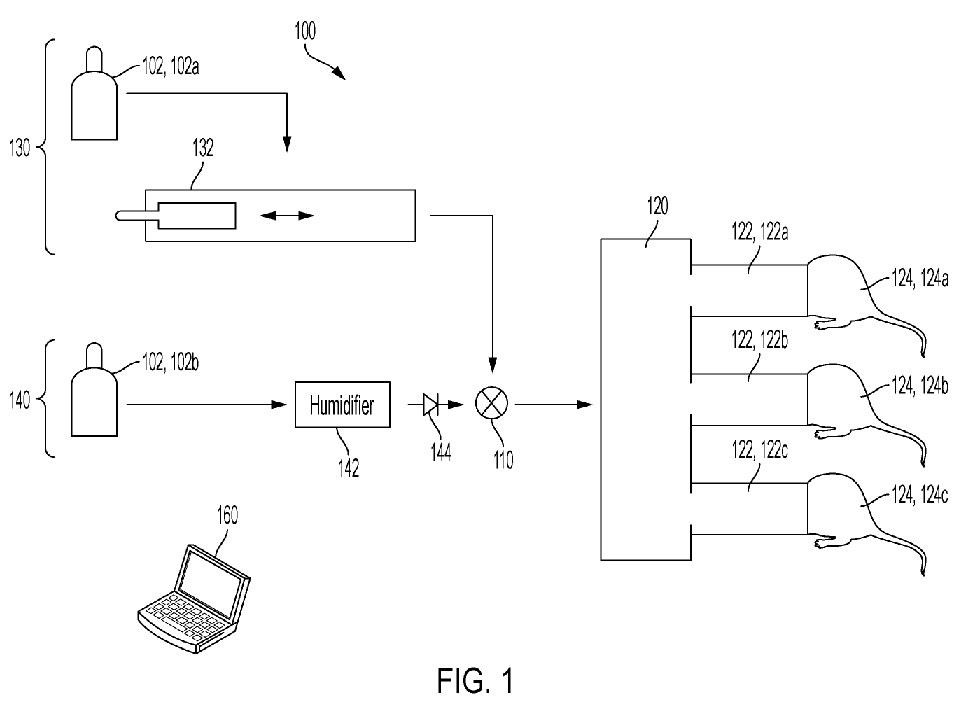

FIG. 1 shows an example NIPPV system 100 for experimental animals 124. As shown, the system is configured to provide NIPPV concurrently to three mice 124, 124a-c. However, other experimental animals 124 including, but not limited to, rats, rabbits, and ferrets are also within the scope of this disclosure, as are greater and smaller numbers of experimental animals 124 concurrently receiving NIPPV from the system 100. In one example, up to twenty-four mice are exposed to NIPPV at one time. That is, the scope of the disclosure is not limited to the specific configuration of the example system 100 illustrated in FIG. 1.

In one embodiments, during exposure, each experimental animal 124 (e.g., mice 124a-c) can be placed in a non-constricting cuff, e.g., made of a nitrile glove tip stretched over a cut-off syringe. The non-constricting cuff forms a seal with the nose and mouth of an associated animal 124, so that the pressurized gas (e.g., air) flows through the animal’s mouth and/or nose and into the animal’s lungs, without the need for a tracheostomy. Each cuff is associated with a separate branch 122 of the system 100. Each separate branch may also include a temperature-controllable pad configured to provide warmth to the animal 124. As shown in FIG. 1, the example system 100 includes three branches 122, 122a-c, each branch providing NIPPV to each separate animal 124a-c concurrently. The branches 122, in turn, receive pressurized gas from a common plenum 120 or chamber. That is, the pressure in the plenum 120 defines the pressure provided to each branch 122. Thus, the plenum 120 acts as a manifold to the separate branches 122.

The pressure in the plenum 120 may include the combined pressure from a dynamic-pressure circuit 130 and a continuous positive-pressure circuit 140. That is, the positive-pressure circuit 140 provides a baseline pressure that is greater than ambient air pressure, and the dynamic-pressure circuit 130 provides a dynamic, i.e., time-varying, pressure. These two circuits 130, 140 may be combined such that the aggregate pressure is applied to the plenum 120. Each of these circuits 130, 140 may include a dedicated gas source 102, 102a-b. In some examples, the system 100 uses a single gas source 102 for both circuits 130, 140. Gas sources 102 may include dedicated bottles or tanks of gas and/or shared sources, such as supplied by a hospital or laboratory environment. If the gas source 102 is shared, the system may include an accumulator tank between the gas source and the rest of the system to absorb variations in pressure of the shared source 102. One or more of the gas sources 102 may include an oxygen source. The oxygen source may be blended with gases from, e.g., other gas sources 102, to achieve a desired mole fraction of oxygen, e.g., using a gas blender. In some examples, the desired fraction of oxygen is sufficient to cause hyperoxia (or be blended to cause hypoxia) in the animal 124. As shown, the continuous positive-pressure circuit 140 also includes a humidifier 142 configured to add moisture content to the blended gas. In some examples, the dynamic-pressure circuit 130 may also include a humidifier 142. In embodiments as shown in FIG. 1, the humidifier 142 is configured to provide appropriate moisture content for both circuits 130, 140. The continuous positive-pressure circuit 140 may also include a one-way check valve 144, e.g., to prevent back-flow due to pressure of the dynamic-pressure circuit 130.

As described above with respect to the continuous positive-pressure circuit 140, the dynamic-pressure circuit 130 may also include one or more gas sources 102 configured to provide a blended gas having a desired mole fraction of oxygen. In some examples, the oxygen fraction of the dynamic-pressure circuit 130 is different than the oxygen fraction of the continuous positive-pressure circuit 140. The dynamic-pressure circuit 130 also includes a mechanical pump 132 configured to vary the pressure in the dynamic-pressure circuit 130. As shown, the mechanical pump 132 is a reciprocating pump including a piston within a cylinder. However, other forms of mechanical pumps are also within the scope of this disclosure, including diaphragm pumps. The mechanical pump 132 may alternate between drawing in gas from the dynamic-pressure circuit 130 (thus reducing the pressure in the circuit 130), and expelling gas into the dynamic-pressure circuit 130 (thus increasing the pressure in the circuit 130).

The dynamic-pressure circuit 130 and the continuous positive-pressure circuit 140 can be joined at a coupling 110, such as a tee, and the combined pressure from both circuits is fed to the plenum 120. As described above, the continuous positive-pressure circuit 140 may also include a one-way check valve 144, e.g., to prevent back-flow due to pressure of the dynamic-pressure circuit 130. Furthermore, the plenum 120 may include a controllable leak, e.g., to compensate for animal movement, pressure drift, etc. The controllable leak may be a manually adjustable leak or may be operated by the control system described below. The plenum 120 may also include a relief valve configured to release pressure if it exceeds a threshold. In some examples, the system 100 also includes a nebulizer or similar device configured to introduce a therapeutic compound into the dynamic-pressure circuit 130 and/or the continuous positive-pressure circuit 140.

Furthermore, the system may be configured and operated by a control system. The control system may include hardware and/or software components. That is, the control system may include sensors and actuators, such as pressure sensors, position sensors, temperature and/or humidity sensors, motion controllers, and so forth. In some examples, the control system includes software that is executed by a processor of one or more electronic device 160. The electronic device 160 may include a user interface that allows a user to configure and/or monitor aspects of the system 100. For example, the control system may include a graphical user interface configured to receive user input. The user input may include operating parameters of the system 100 including, but not limited to, operating parameters of the mechanical pump 132. In some examples, the control system operates to maintain the temperature of the temperature-controllable pads within an appropriate range for the animal, such as between 28 and 30 degrees Celsius. The control system may be configured to maintain user settings by applying an appropriate feedback algorithm, such as a PID loop. In some examples, the control system is implemented on a commercial SCADA system.

The control system may also track information over time. For example, the control system may track temperatures, pressures, etc. and present the tracked information on a display, e.g., as a strip chart. In some examples, the control system may log recorded data to allow for after-the-fact analysis and/or comparing information recorded at different periods of time. Furthermore, the logged information may be used to optimize the system for future use. For example, supervised and/or unsupervised machine-learning algorithms may be applied to identify or detect patterns or trends that are otherwise not obvious.

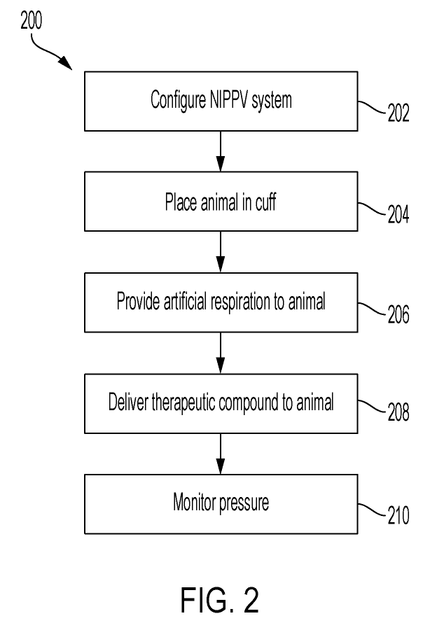

FIG. 2 shows a flowchart 200 for an example method of preparing an animal model. Preparing an animal model may include conditioning tissue of the animal to emulate physiology and/or anomalies of human tissue. At step 202, the method includes configuring a NIPPV system 100 to provide a time-varying pressure having: (i) a positive end-expiratory pressure which is greater than ambient air pressure; (ii) a peak inspiratory pressure which is greater than the positive end-expiratory pressure; (iii) an inspiratory duration; and (iv) and inspiration rate. In some examples, configuring the NIPPV system 100 to provide the time-varying pressure includes configuring a dynamic-pressure circuit 130 and/or a continuous positive-pressure circuit 140 of the NIPPV system 100. For example, configuring the positive end-expiratory pressure may include configuring the pressure of the continuous positive-pressure circuit 140. Configuring the pressure of the continuous positive-pressure circuit 140 may include adjusting parameters of the gas source(s) 102, adjusting and pressure regulators and/or pressure relief valves, and so on. In some examples, any or all of these adjustments may be performed by the control system.

Similarly, for a dynamic-pressure circuit 130 that includes a reciprocating mechanical pump 132, configuring the inspiratory duration and/or inspiration rate may include configuring the mechanical pump 132. That is, the mechanical pump 132 may be configured to repeatedly perform a cycle that includes an inspiration portion, during which pressure in the dynamic-pressure circuit is increased. In this case, the length of the inspiration portion may reflect the inspiration duration, and the complete cycle time of the pump 132 may reflect the inspiration rate. Thus, configuring the inspiration duration and the inspiration rate includes configuring the mechanical pump 132 to have a corresponding inspiration portion and the complete cycle time. Similarly, configuring the peak inspiratory pressure may include configurating a maximum output pressure of the mechanical pump 132. For example, the peak inspiratory pressure may be the sum of the pressure of the continuous positive-pressure circuit 140 (configured as described above) and the maximum output pressure of the mechanical pump 132. In some examples, the inspiration rate is about 30 times per minute, the inspiration time is about 0.7 seconds, the positive end-expiratory pressure is about 6 cm of water above ambient, and the peak inspiratory pressure is about 14 cm of water.

At step 204, the method includes placing at least one animal 124 in an elastic cuff configured to form a seal with a nose and mouth of the animal. The elastic cuff may be interfaced with a branch of the NIPPV system 100 to provide a time-varying positive pressure to the animal 124 (e.g., as artificial respiration). At step 206, the method includes providing the artificial respiration to the animal 124 for a period of time during each of several days. For example, the NIPPV system 100 may provide artificial respiration for six hours for four consecutive days. Providing artificial respiration to the animal 124 in this way may cause a characteristic of the animal 124 to approximate a pathological condition of a human infant, such as lung stiffness of a human with bronchopulmonary dysplasia (BPD). Other types of tissue including, but not limited to, cardiac tissue, and other tissue characteristics are also within the scope of this disclosure.

At step 208, the method includes the optional step of delivering, by the non-invasive ventilation system, one or more therapeutic compounds to the animal 124. At step 210, the method includes the optional step of monitoring, by the control system, the time-varying pressure of the NIPPV system 100, and/or other aspect of the NIPPV system 100 including, but not limited to, the temperature of the temperature-controllable pads. Monitoring the time-varying pressure may include displaying the pressure on a display device operated by the control system. Monitoring the time-varying pressure may also include generating alarms if the time-varying pressure deviates from the configured parameters by more than a threshold amount. Generating alarms may include generating audio and/or visual alarms, and/or sending text or e-mail messages.

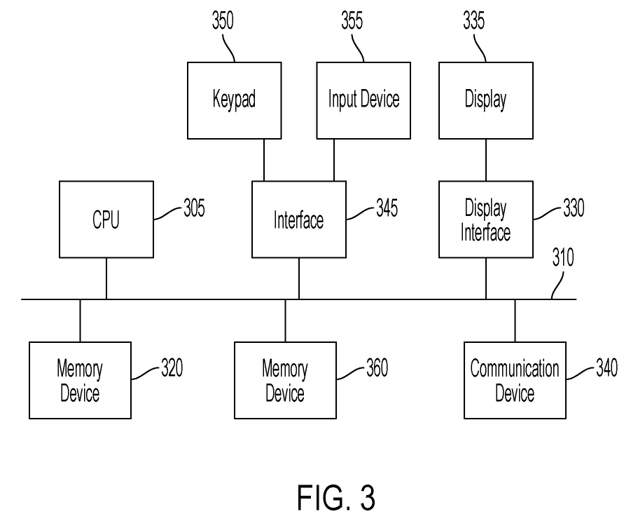

FIG. 3 illustrates example hardware that may be used to contain or implement program instructions. A bus 310 serves as the main information highway interconnecting the other illustrated components of the hardware. Central Processing Unit (CPU) 305 is the central processing unit of the system, performing calculations and logic operations required to execute a program. CPU 305, alone or in conjunction with one or more of the other elements disclosed in FIG. 3, is an example of a processor as such term is used within this disclosure. Read only memory (ROM) and random-access memory (RAM) constitute examples of non-transitory computer-readable storage media 320, memory devices or data stores as such terms are used within this disclosure.

Program instructions, software or interactive modules for providing the interface and performing any querying or analysis associated with one or more data sets may be stored in the memory device 360. Optionally, the program instructions may be stored on a tangible, non-transitory computer-readable medium such as a compact disk, a digital disk, flash memory, a memory card, a universal serial bus (USB) drive, an optical disc storage medium and/or other recording medium.

An optional display interface 330 may permit information from the bus 310 to be displayed on the display 335 in audio, visual, graphic or alphanumeric format. Communication with external devices may occur using various communication devices and/or ports 340. A communication port 340 may be attached to a communications network, such as the Internet or an intranet. Communication devices may include wireless transceivers for receiving and/or relaying telemetry. That is, a transceiver may comprise both a transmitter and a receiver.

The hardware may also include an interface 345 which allows for receipt of data from input devices such as a keypad 350 or other input device 355 such as a touch screen, a remote control, a pointing device, a video input device and/or an audio input device.

While this disclosure describes example embodiments for example fields and applications, it should be understood that the disclosure is not limited to the disclosed examples. Other embodiments and modifications thereto are possible and are within the scope and spirit of this disclosure. For example, and without limiting the generality of this paragraph, embodiments are not limited to the software, hardware, firmware, and/or entities illustrated in the figures and/or described in this document. Furthermore, embodiments (whether or not explicitly described) have significant utility to fields and applications beyond the examples described in this document.

Embodiments have been described in this document with the aid of functional building blocks illustrating the implementation of specified functions and relationships. The boundaries of these functional building blocks have been arbitrarily defined in this document for the convenience of the description. Alternate boundaries can be defined as long as the specified functions and relationships (or their equivalents) are appropriately performed. Also, alternative embodiments can perform functional blocks, steps, operations, methods, etc. using orderings different than those described in this document.

The features from different embodiments disclosed herein may be freely combined. For example, one or more features from a method embodiment may be combined with any of the system or product embodiments. Similarly, features from a system or product embodiment may be combined with any of the method embodiments herein disclosed.

References in this document to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Furthermore, when a particular feature, structure, or characteristic is described in connection with an embodiment, it would be within the knowledge of persons skilled in the relevant art(s) to incorporate such feature, structure, or characteristic into other embodiments, whether or not explicitly mentioned or described in this document. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but still co-operate or interact with each other.

While the invention has been described with specific embodiments, other alternatives, modifications and variations will be apparent to those skilled in the art. Accordingly, it will be intended to include all such alternatives, modifications, and variations within the spirit and scope of the appended claims.

1. A non-invasive ventilation system comprising:
a plenum chamber configured to provide pressure to one or more branches, each of the one or more branches configured to provide the pressure of the plenum chamber to a separate animal;
a dynamic pressure circuit interfacing with the plenum chamber, the dynamic pressure circuit comprising a ventilator configured to apply a time-varying pressure to the plenum chamber;
a continuous pressure circuit interfacing with the plenum chamber through a check valve, the continuous pressure circuit configured to apply a positive pressure to the plenum chamber; and
a control system configured to operate the ventilator to provide the time-varying pressure.

2. The non-invasive ventilation system of claim 1, wherein the continuous pressure circuit further comprises a humidifier.

3. The non-invasive ventilation system of claim 1, wherein:
the one or more branches comprises a plurality of branches, each of the plurality of branches associated with a separate animal;
each separate animal comprises a nose and a mouth; and
each of the plurality of branches comprises an elastic cuff configured to form a seal with the nose and mouth of the associated animal.

4. The non-invasive ventilation system of claim 1, wherein the plenum chamber comprises an adjustable leak.

5. The non-invasive ventilation system of claim 4, wherein the adjustable leak is a manually adjustable leak.

6. The non-invasive ventilation system of claim 1, wherein the non-invasive ventilation system is further configured to deliver one or more therapeutic compounds to each separate animal.

7. The non-invasive ventilation system of claim 1, further comprising a gas blender configured to adjust a fraction of oxygen in the plenum chamber.

8. The non-invasive ventilation system of claim 1, further comprising one or more temperature-controllable pads interfaced with the control system.

9. A method of preparing an animal model, the method comprising:
configuring the non-invasive ventilation system of claim 1 to provide a time-varying pressure comprising:
a positive end-expiratory pressure being greater than ambient air pressure;
a peak inspiratory pressure being greater than the positive end-expiratory pressure;
an inspiratory duration; and
an inspiratory rate;
placing at least one animal in an elastic cuff configured to form a seal with a nose and mouth of the at least one animal, the elastic cuff interfaced with a branch of the one or more branches to provide artificial respiration to the at least one animal based on the time-varying pressure; and
providing the artificial respiration to the at least one animal for a period of time during each of several days, causing a characteristic of the at least one animal to approximate a pathological condition of a human infant.

10. The method of claim 9, wherein the pathological condition is bronchopulmonary dysplasia.

11. The method of claim 10, wherein the characteristic of the at least one animal is lung stiffness.

12. The method of claim 9, wherein providing the artificial respiration comprises providing the artificial respiration to the at least one animal for up to six hours per day for at least four days.

13. The method of claim 9, wherein configuring the non-invasive ventilation system comprises configuring the continuous pressure circuit to provide the positive end-expiratory pressure.

14. The method of claim 9, wherein configuring the non-invasive ventilation system comprises configuring the control system to operate the ventilator at the inspiratory duration and/or the inspiratory rate.

15. The method of claim 9, wherein the method includes providing the artificial respiration to animals that have not undergone tracheostomy.

16. The method of claim 9, wherein the at least one animal is a non-human mammal.

17. The method of claim 16, wherein the non-human mammal is a rodent or a non-human primate.

18. The method of claim 16, wherein the non-human mammal is a mouse, rabbit, rat, hamster, guinea pig, ferret, cat, dog, or monkey.

19. The method of claim 9, further comprising delivering, by the non-invasive ventilation system, one or more therapeutic compounds to the at least one animal.

20. The method of claim 9, further comprising monitoring, by the control system, the time-varying pressure.

21. A non-human animal prepared according to the method of claim 9.
